(19) United States
(12) Patent Application Publication
(10) Pub. No.: US 2006/0147638 A1
(43) Pub. Date: Jul. 6, 2006

(54) Method for manufacturing nano ink-jet cloth

(76) Inventor: Min Cheng Chuang, Hsin Chuang City (TW)

Correspondence Address: PRO-TECTOR INTERNATIONAL SERVICES, 20775 NORADA CT., SARATOGA, CA, 95070, US

(21) Appl. No.: 11/030,819

(22) Filed: Jan. 6, 2005

(51) Int. Cl. B05D 3/12; B05D 3/02; B05D 1/36

(52) U.S. Cl. 427/361; 427/402; 427/372.2

(57) ABSTRACT

The present invention discloses a method for manufacturing nano ink-jet cloth by the processes of: using a calendering machine to calender a refined polyest; adding a wetting agent and a hard resin to the calendered polyest; using a boarding machine to bake the polyest dry until a cloth of 61-inch wide with pinholes is formed; coating the cloth with a waterproof PU and a nano paint; and then heating and drying the cloth to produce a nano ink-jet cloth, such that the ink-jet cloth can be printed by an ink-jet printer or a printing machine to produce portraits, identity photos, advertising, purses or handbags, and the finished goods can be kept permanently with a vivid non-yellowing effect.

### BACKGROUND OF THE INVENTION

1. Field of the Invention

The present invention relates to a method for manufacturing nano ink-jet cloth, more particularly to a method for manufacturing cloths that can be printed by an ink-jet printer or a printing machine.

2. Description of the Related Art

In general, an ink-jet printer or a printing machine can only print texts and graphics on different kinds of paper, but cannot print cloths. Since it is necessary to cut a great deal of trees to make paper, which will cause crises to the water and soil reservation and environmental protection, and some products requiring cloth materials for the style of their expression such as painting, faked antique painting, advertising, handbags and various personalized commercial products, therefore it is difficult to show a special effect if the aforementioned products are made of paper. However, the current existing cloths cannot be printed by a printer or a printing machine. The traditional cloths can only be dyed, which is very troublesome and does not comply with the requirements of environmental protections. The patterns so printed cannot meet our expected standard and the color is not as vivid either.

### SUMMARY OF THE INVENTION

In view of the shortcomings of the prior art, the inventor of the present invention based on years of experience in the related field to conduct extensive research and development to overcome the foregoing shortcomings and find a solution for the improvement, and finally invented a method for manufacturing nano ink-jet cloth in accordance with the present invention.

Therefore, it is a primary objective of the present invention to provide a method for manufacturing nano ink-jet cloth that can be printed by an ink-jet printer or a printing machine to enhance the value of the cloths.

The foregoing manufacturing method comprises the steps of calendering a refined polyest at a speed of 20 meters per minute and a temperature of 150□; adding a wetting agent (such as alkylbezene sulfonate) and a hard resin to improve the liquid (ink) absorbability of a long-fiber cloth; and drying a 61-inch wide cloth with pinholes by operating a boarding machine at a speed of 30 meters per minute and a temperature of 170□.

The aforementioned manufacturing method further uses a coating machine operated at a speed of 30 meters per minute and a temperature of 170□ to coat a layer of waterproof PU to achieve the reverse osmosis (RO) waterproof effect, and then uses the coating machine operated at a speed of 25 meters per minute to coat an even layer of nano paint, and after heating the cloth to 180□, the cloth is dried at room temperature for one to two days to produce the nano ink-jet cloth.

The nano paint adopted in the foregoing manufacturing method is composed of 41% calcium carbonate (CaCO₃), 8.6% barium carbonate (polyvinyl abol, PVA), 4.1% polyamine derivative (fastness accelerator), 8% acrylic resin, 4.1% polypropylene emulsion (binder), 16.4% polyvinyl acetate resin (PVAc Resin), 8.2% titanium dioxide (TiO₂) and 9.6% water. The foregoing matters are blended and evenly mixed for 30 minutes by a blender.

### BRIEF DESCRIPTION OF THE DRAWINGS

FIGS. 1 and 2 two are flow charts of the manufacture according to the present invention.

FIG. 3 is a perspective view of the nano ink-jet cloth of the present invention.

### DETAILED DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

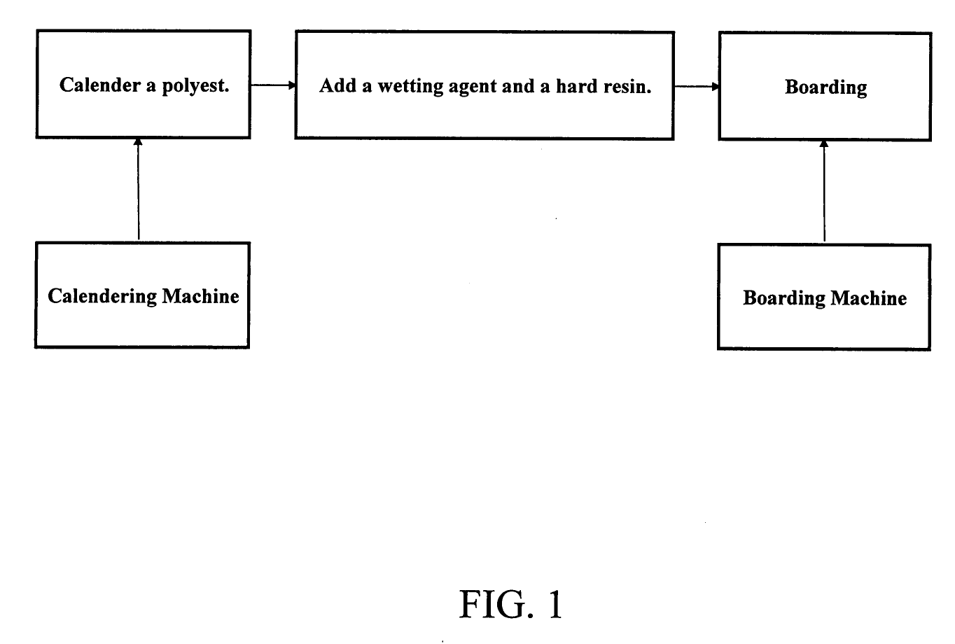

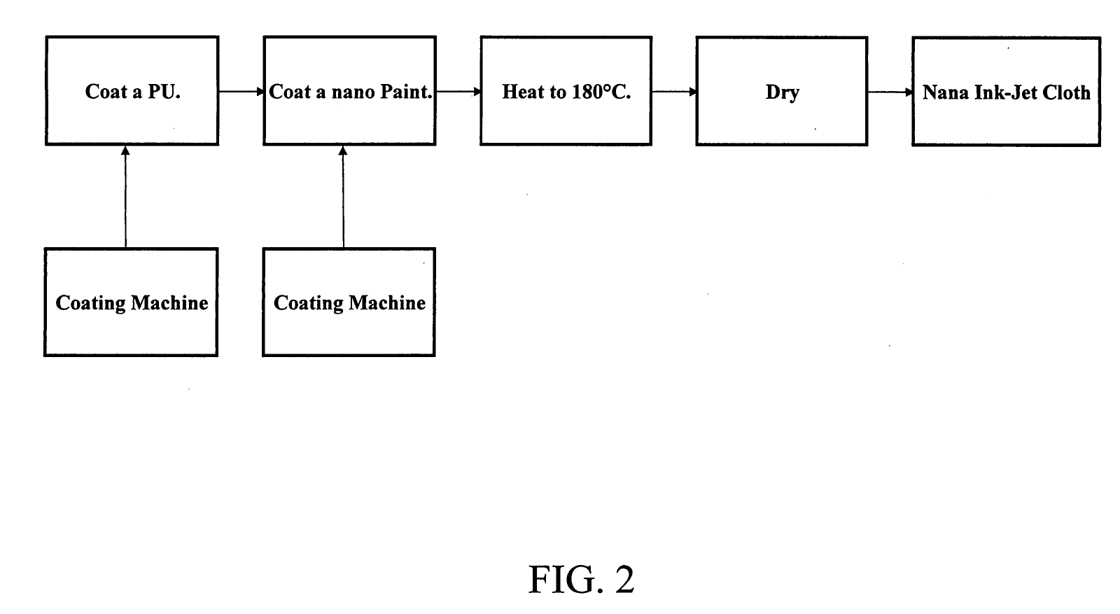

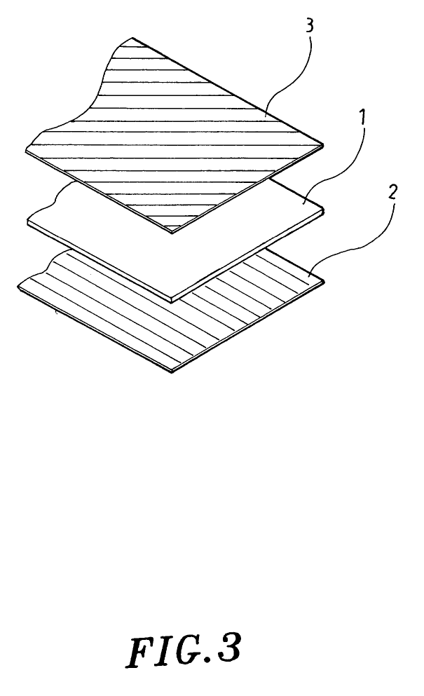

Please refer to FIGS. 1 to 3 for the manufacturing method in accordance with the present invention, which comprises the steps of:

1. calendering a refined polyest (with a 100% composition) by a calendering machine operated at a temperature of 150□ and a speed of 20 meters per minute;

2. adding 2% alkylbezene sulfonate (a wetting agent) and 40% hard resin, 60% acrylic, and 40% polyvinyl acetate resin to improve the water (ink) absorbability of a long-fiber cloth;

3. drying a 61-inch wide cloth 1 with pinholes by operating a boarding machine operated at a speed of 30 meters per minute and a temperature of 170□;

4. using a coating machine operated at a speed of 30 meters per minute and a temperature of 170□ to coat a layer of waterproof PU 2 onto the cloth 1 to achieve the reverse osmosis (RO) waterproof effect;

5. using the coating machine operated at a speed of 25 meters per minute to coat an even layer of nano paint 3 onto the cloth 1; and

6. heating the cloth 1 coated with the waterproof PU 2 and the nano paint 3 to 180□ and then drying it at room temperature for one to two days to produce the nano ink-jet cloth.

The nano paint 3 adopted by the present invention is composed of 41% calcium carbonate (CaCO₃), 8.6% barium carbonate (polyvinyl abol, PVA), 4.1% polyamine derivative (fastness accelerator), 8% acrylic resin, 4.1% polypropylene emulsion (binder), 16.4% polyvinyl acetate resin (PVAc Resin), 8.2% titanium dioxide (TiO₂) and 9.6% water.

The foregoing matters are blended and evenly mixed for 30 minutes by a blender to produce the nano paint 3 for being coated onto the foregoing cloth 1.

The nano ink-jet cloth so produced can be printed with different texts or graphics by an ink-jet printer or a printing machine to produce painting, faked antique painting, advertising, handbags and various cloth products. The specifications of the nano ink-jet cloth cover the A6, A4, A3, rolling and other special formats and are applicable for the ink-jet printer or the printing machine of various brands. Such ink-jet cloth has the following advantages:

1. This ink-jet cloth complies with requirements of environmental protection, and does not contain toxic constitutes such as phosphorous, chlorine, and fluorescent agents.

2. This ink-jet cloth is heat-resisting, discontinuously combustible and not affected by humidity and low temperature.

3. This ink-jet cloth can be printed with bright colors without blurs and it is durable and not easy to be torn.

4. The dye-type or paint-type ink can be used for such ink-jet cloth.

5. This ink-jet cloth can be stored permanently and will not becoming yellowed or moldy.

In summation of the description above, the nano ink-jet cloth of the present invention keeps the surface waterproof, and thus providing a high adhesion for the ink, and thus the present invention is definitely a practical design and further complies with the patent application requirements and is submitted to the Patent and Trademark Office for review and granting of the commensurate patent rights.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for manufacturing nano ink-jet cloth, comprising the steps of:
a. calendering a refined polyest by a calendering machine operated at a temperature of 150□ and a speed of 20 meters per minute;
b. adding 2% alkylbezene sulfonate wetting agent and 40% hard resin to said polyest after being calendered;
c. drying a 61-inch wide cloth with pinholes by a boarding machine operated at a speed of 30 meters per minute and a temperature of 170□;
d. using a coating machine operated at a temperature of 170□ and a speed of 30 meters per minute to coat a layer of waterproof PU onto said cloth;
e. using said coating machine operated at a speed of 25 meters per minute to coat an even layer of nano paint onto said cloth; and
f. heating said cloth coated with said waterproof PU and said nano paint to 180□ and then drying said cloth at room temperature for one to two days to produce said nano ink-jet cloth.

2. The method for manufacturing nano ink-jet cloth of claim 1, wherein said nano paint coated onto said cloth is composed of 41% calcium carbonate (CaCO₃), 8.6% barium carbonate (polyvinyl abol, PVA), 4.1% polyamine derivative (fastness accelerator), 8% acrylic resin, 4.1% polypropylene emulsion (binder), 16.4% polyvinyl acetate resin (PVAc Resin), 8.2% titanium dioxide (TiO₂) and 9.6% water.

3. The method for manufacturing nano ink-jet cloth of claim 1, wherein said hard resin is composed of 60% acrylic resin and 40% polyvinyl acetate resin (PVAc Resin).

4. The method for manufacturing nano ink-jet cloth of claim 1, wherein said nano paint with its constituents are mixed by a blender for 30 minutes to produce an even mixture.
